(19) United States
(12) Patent Application Publication
(10) Pub. No.: US 2009/0147250 A1
(43) Pub. Date: Jun. 11, 2009

(54) SEMICONDUCTOR WAFER SURFACE INSPECTION APPARATUS

(75) Inventors: Terunori TANAKA, Tokyo (JP); Eiji KAMIYAMA, Tokyo (JP)

Correspondence Address: GREENBLUM & BERNSTEIN, P.L.C., 1950 ROLAND CLARKE PLACE, RESTON, VA, 20191, US

(73) Assignee: SUMCO CORPORATION, Tokyo (JP)

(21) Appl. No.: 12/328,216

(22) Filed: Dec. 4, 2008

(30) Foreign Application Priority Data
Dec. 5, 2007 (JP) 2007-315154

(51) Int. Cl. G01N 21/88

(52) U.S. Cl. 356/237.5

(57) ABSTRACT

The present invention provides an apparatus for inspecting the surface of a semiconductor wafer having a mirror surface and a chamfered outer circumferential portion by holding the outer circumferential portion of the semiconductor wafer, keeping the semiconductor held in the vertical direction and moving an inspection microscope lens toward the surface of the semiconductor wafer. The apparatus includes a wafer holding member holding the semiconductor wafer and including two or more contact portions that contact the outer circumferential portion of the semiconductor wafer. The contact portions include: a front surface contact portion that contacts a front-surface-side position of a chamfered portion of the semiconductor wafer; and a rear surface contact portion that contacts a rear-surface-side position of the chamfered portion of the semiconductor wafer at the same position as that where the front surface contact portion is arranged in the circumferential direction of the semiconductor wafer.

### BACKGROUND OF THE INVENTION

1. Field of the Invention

The present invention relates to a technique applicable for a semiconductor wafer surface inspection apparatus.

Priority is claimed on Japanese Patent Application No. 2007-315154, filed Dec. 5, 2007, the content of which is incorporated herein by reference.

2. Description of Related Art

During a process of inspecting the surface of a silicon wafer, for example, when microscope inspection is performed, generally, a surface (rear surface) of the silicon wafer opposite an inspection surface contacts an inspection stage or the rear surface of the wafer is drawn to the stage. In this case, during the inspection of a wafer surface, a microscope is used to inspect an uneven portion having a height in the range of 0.1 to 10 nm. Therefore, an object lens of the microscope is moved relative to the semiconductor wafer in the in-plane direction of the semiconductor wafer to perform scanning, while the distance between the object lens of the microscope and the wafer surface is set to about 10 mm with a magnifying power of 10, in the range of about 1 to 4 mm with a magnifying power of 100, or in the range of 200 to 3000 μm according to the length measurement conditions.

In addition, a unit that draws a wafer to prevent the vibration of the wafer in the inspection stage has been proposed in, for example, JP-A-2002-039745.

However, in an inspection method of loading a wafer on the inspection stage and inspecting the wafer, a contact portion is likely to be scratched or damaged, or metal particles of the stage are likely to be adhered to the surface of the wafer. In this case, the rear surface of the wafer is also scratched or damaged, and metal particles are also adhered to the rear surface of the wafer. Therefore, it is difficult to inspect the wafer without causing damage.

In particular, since the surface of the wafer opposite to an inspection surface, that is, the front surface of the wafer is a device region and the front surface contacts the stage, it is difficult to inspect the rear surface of the wafer in a nondestructive manner.

In order to solve the above problems, a structure that holds only the circumferential portion (edge portion) of a wafer and performs inspection has been proposed in JP-A-2003-243465 (FIG. 9 and others). In this case, the wafer is supported such that its front surface (inspection surface) is arranged in the horizontal direction, and the distance between the wafer and a microscope lens is set in the above-mentioned range.

Further, a structure that supports only the edge of a wafer has been proposed in Japanese Patent No. 3744176.

However, as described in JP-A-2003-243465, when only the edge of the wafer is held by the inspection stage, the wafer is curved due to its own weight, and the minute vibration of an apparatus is likely to be transmitted to the wafer. As a result, the center of the wafer is vibrated with a maximum amplitude in the range of about 200 to 300 μm, which depends on a scanning speed.

In particular, when inspection is performed with a high magnifying power, the amplitude of the vibration of the wafer is likely to be equal to the distance between the object lens and the wafer. As a result, an optical part, such as the lens, may contact the wafer.

In this case, even though the lens does not contact the wafer, the vibration of the wafer makes it difficult to focus the lens on the surface of the wafer, obtain a clear image, and accurately perform measurement during inspection. As a result, it is difficult to obtain accurate measurement results.

When the edge (circumferential portion) of the wafer is held in the horizontal direction, the wafer is curved due to its own weight, and the parallelism between the wafer and the microscope lens is lowered. Therefore, when the wafer is scanned (at a high speed) while changing observation positions in a wide ranges the lens is likely to contact the wafer. In general, the microscope is moved to an observation position and then focused thereon. However, when the parallelism between the wafer and the lens is lowered, the microscope contacts the wafer before the focusing operation. Therefore, whenever each point on the plane of the wafer is measured, an operation of moving the wafer in the in-plane direction such that the object lens corresponds to each measurement point and focusing the microscope on the measurement point is repeatedly performed. In this case, the speed of relative movement between the object lens and the wafer is lowered. As a result, the time required to inspect the surface of a wafer is increased, which is not preferable.

### SUMMARY OF THE INVENTION

The present invention has been made in order to solve the above problems and achieve the following objects:

1. To prevent the contact between a wafer and an object lens during microscope inspection;

2. To prevent metal particles from being adhered to the front and rear surfaces of a wafer and prevent the front and rear surfaces of the wafer from being scratched or damaged during inspection;

3. To prevent the vibration of a wafer dug inspection;

4. To maintain a constant distance between an object lens and the surface of a wafer during inspection; and

5. To reliably provide a focus area on the surface of a wafer during inspection.

According to an aspect of the present invention, there is provided an apparatus for inspecting the surface of a semiconductor wafer having a mirror surface and a chamfered outer circumferential portion by holding the outer circumferential portion of the semiconductor wafer, keeping the semiconductor wafer held in the vertical direction and moving an inspection microscope lens toward the surface of the semiconductor wafer. The apparatus includes: a wafer holding member holding the semiconductor wafer and including two or more contact portions that contact the outer circumferential portion of the semiconductor wafer. The contact portions include: a front surface contact portion that contacts a front-surface-side position of a chamfered portion of the semiconductor wafer; and a rear surface contact portion that contacts a rear-surface-side position of the chamfered portion of the semiconductor wafer at the same position as that where the front surface contact portion is arranged in the circumferential direction of the semiconductor wafer.

In the semiconductor wafer surface inspection apparatus according to the above-mentioned aspect, preferably, the curvature of a contact surface of the contact portion in the direction of the central axis of the semiconductor wafer is set to be equal to the curvature of the chamfered portion of the semiconductor wafer in order to prevent the vibration of the semiconductor wafer.

In the semiconductor wafer surface inspection apparatus according to the above-mentioned aspect, preferably, the wafer holding member includes a vibration preventing unit supporting the contact portion that is positioned above the center of the semiconductor wafer held in the vertical direction such that the contact portion can slide in the direction of the central axis of the semiconductor wafer.

In the semiconductor wafer surface inspection apparatus according to the above-mentioned aspect, preferably, at least one contact portion is provided below the center of the semiconductor wafer held in the vertical direction, and one contact portion is provided above the center of the semiconductor wafer held in the vertical direction.

According to the above-mentioned aspect of the present invention, the edge of the wafer is held in the vertical direction. Therefore, it is possible to minimize the vibration of a wafer due to an apparatus and inspect the wafer in a non-destructive manner, without the contact between the front and rear surfaces and the apparatus.

In the above-mentioned structure, the wafer is held in the vertical direction to prevent the vibration of the wafer. When the apparatus is mounted to a shock-absorbing desk, it is possible to obtain a clearer image and a more accurately measured value.

Since there are no contact portions between the front and rear surfaces of a wafer and the apparatus, the wafer is not scratched, damaged, or contaminated the metal particles, and it is possible to inspect the front and rear surfaces of the wafer using a microscope in a nondestructive manner. Therefore, it is not necessary to prepare extra wafers for microscope inspection, and it is possible to improve yield and productivity.

Furthermore, since the wafer is held in the vertical direction, it is possible to reduce the influence of particles falling from the apparatus. As a result, it is possible to prevent deterioration of the quality of a wafer during inspection.

Further, since the wafer is held in the vertical direction, it is possible to prevent the wafer from being curved due to its own weight. Therefore, it is possible to maintain the parallelism between a microscope lens and a wafer. As a result, even when scanning is performed at a high speed in the X and Y directions, it is possible to form a focus.

### BRIEF DESCRIPTION OF THE DRAWINGS

FIG. 1 is a side view illustrating the inspection state of a semiconductor wafer surface inspection apparatus according to an embodiment of the present invention;

FIGS. 2A and 2B are front views illustrating a portion of the semiconductor wafer surface inspection apparatus according to the embodiment of the present invention;

FIG. 3 is a side view illustrating a holding member and a silicon wafer;

FIGS. 4A and 4B are a side view and a front view illustrating the relationship between an inspection microscope lens and a silicon wafer, respectively;

FIG. 5 is a side view illustrating a contact portion;

FIG. 6 is a side view illustrating a contact portion;

FIG. 7 is a side view illustrating a contact portion; and

FIG. 8 is a front view illustrating a robotic hand.

### DETAILED DESCRIPTION OF THE INVENTION

Hereinafter, a semiconductor wafer surface inspection apparatus according to an embodiment of the present invention will be described with reference to the accompanying drawings.

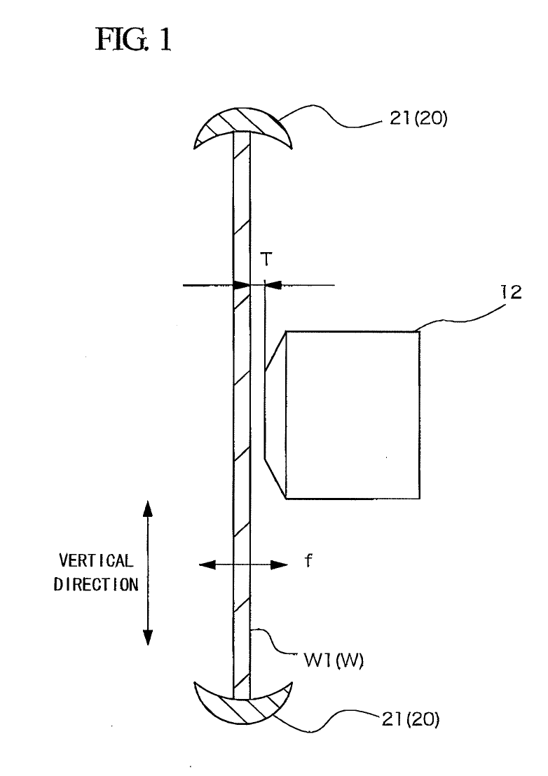

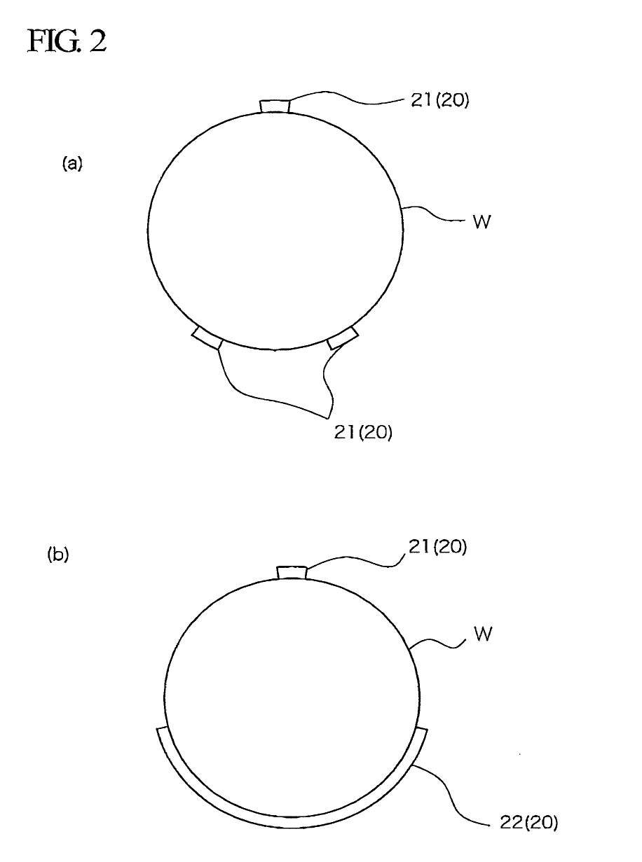

FIG. 1 is a side view illustrating the inspection state of the semiconductor wafer surface inspection apparatus according to the embodiment of the present invention, and FIGS. 2A and 2B are front views illustrating a portion of the semiconductor wafer surface inspection apparatus according to this embodiment. In FIGS. 1, 2A and 2B, reference numeral 20 denotes a holding member.

As shown in FIG. 1, the semiconductor wafer surface inspection apparatus (silicon wafer inspection apparatus) according to this embodiment includes the holding member 20 that holds a circumferential portion of a silicon wafer W, which is an example of a semiconductor wafer, such that the surface of the wafer is arranged in the vertical direction, and au Inspection microscope lens 12 that serves as a surface inspection unit for inspecting a front surface W1 of the silicon wafer W and scans the front surface of the wafer W in the in-plane direction to inspect the surface of the wafer W. FIG. 1 shows only a portion of the holding member 20 that contacts the wafer.

The silicon wafer W is obtained by performing a block cutting process, a wafer cutting process, a chamfering process, a mechanical/chemical polishing process, and an RCA cleaning process on a single silicon crystal rod pulled by a CZ method. The front surface W1 of the silicon wafer W is a mirror surface.

The holding member 20 includes two or more contact portions 21 that contact the circumferential portion of the silicon wafer. As shown in FIG. 2A, the contact portions 21 include at least one contact portion that is positioned below the center of the silicon wafer W held in the vertical direction and a contact portion that is positioned above the center of the silicon wafer.

Specifically, as shown in FIG. 2A, the holding member 20 includes three contact portions 21. That is, one contact portion is positioned at the top of the silicon wafer W held in the vertical direction, and two contact portions are positioned at a center angle in the range of 10 to 50° from the lowermost portion of the silicon wafer W.

As shown in FIG. 2B, the holding member 20 may include a contact portion 21 that is positioned at the top of the silicon wafer W held in the vertical direction and a contact portion 22 that is positioned along the outer circumference of the silicon wafer W at a center angle in the range of −50 to −10° and in the range of 10 to 50° from the lowermost portion of the silicon wafer W.

The holding member 20 is movable between a holding position where the contact portion 21 that is provided above the center of the silicon wafer contacts the outer circumferential portion of the silicon wafer W and a release position where the contact portion 21 is separated from the outer circumferential portion of the silicon wafer W, thereby switching between holding and releasing the silicon wafer W.

The upper and lower sides of the silicon wafer W are set according to the holding state of the silicon wafer during an inspection process. The upper and lower sides of the silicon wafer W during transport and the preparation of inspection may also vary.

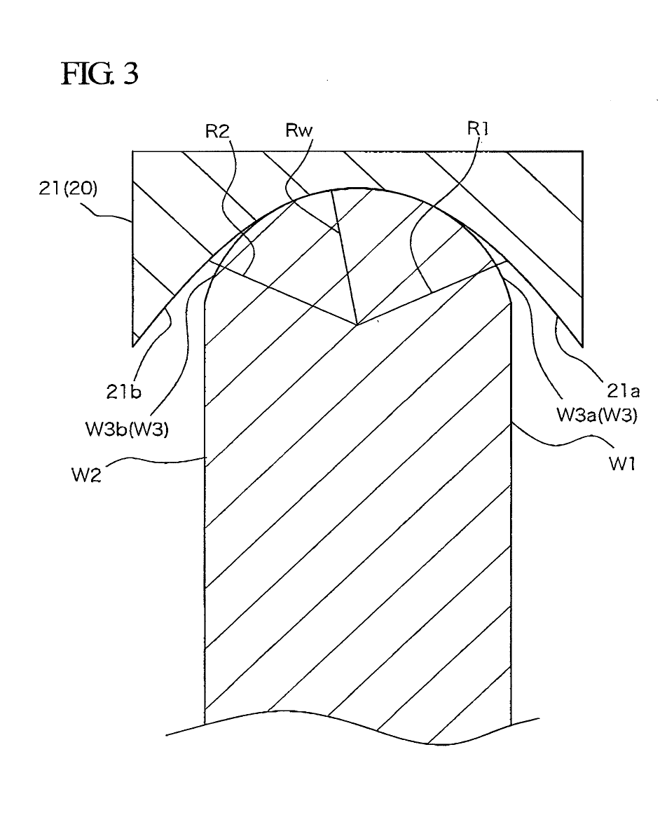

FIG. 3 is a side view illustrating the holding member and the silicon wafer.

As shown in FIG. 3, the contact portion 21 includes a front surface contact portion 21a that contacts a front-surface-side position W3a of a chamfered portion W3 of the semiconductor wafer W and a rear surface contact portion 21b that contacts a rear-surface-side position W3b of the chambered portion W3 of the semiconductor wafer W at the same position as that where the front surface contact portion 21a is arranged in the circumferential direction of the semiconductor wafer W.

The curvature of a contact surface of the contact portion 21 in the direction of the central axis of the semiconductor wafer W is set such that the contact surface curvature R1 of the front surface contact portion 21a and the contact surface curvature R2 of the rear surface contact portion 21b are equal to the curvature Rw of the chamfered portion W3 of the semiconductor wafer W in order to prevent the vibration of the semiconductor wafer W.

The contact portion 21 is made of a fluorine compound resin having sufficient hardness to hold a wafer and reduce vibration.

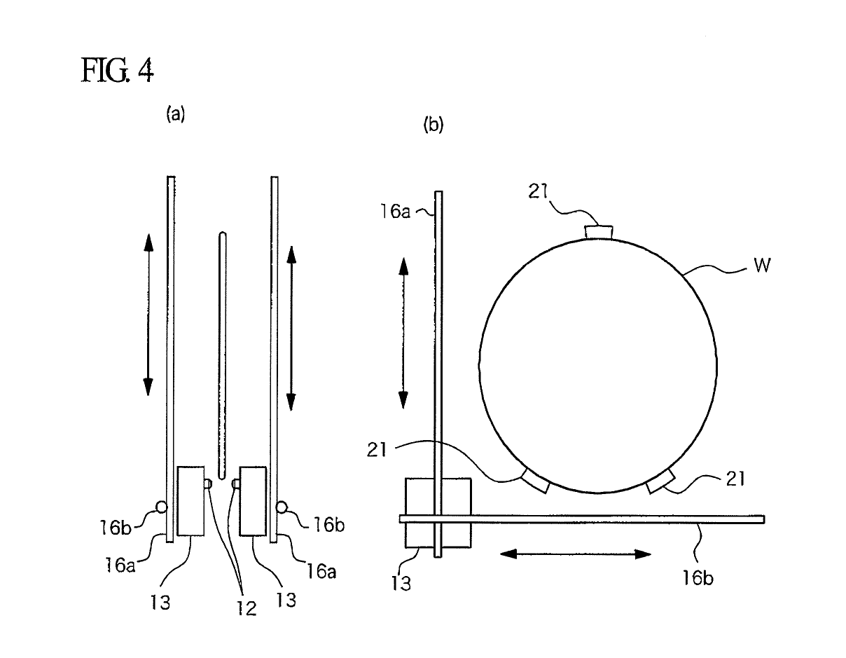

FIG. 4A is a side view illustrating the relationship between an inspection microscope lens and a silicon wafer, and FIG. 4B is a front view illustrating the relationship.

Am inspection microscope lens (surface detecting device) 12 is specifically an object lens of an optical microscope, and is used to observe the front surface W1 of the silicon wafer W in the direction that is vertical to the surface.

The structure of the inspection microscope lens will be described below. The lens of the surface detecting device 12 captures light reflected from the front surface W1 of the wafer to detect the number of a foreign material, cracks, protrusions, COP, and contaminated particles from the surface of the silicon wafer W.

As the microscope, for example, a general optical microscope, a laser microscope, or a DTV microscope may be used. However, any microscope may be generally used as long as it has a general microscope lens, regardless of the maker and shape of the microscope.

As shown in FIGS. 4A and 4B, the inspection microscope lens 12 is provided on a moving portion 13 that is movable in the plane in the vertical direction by a scanning unit. The scanning unit includes a rail 16a for movement in the vertical direction, a rail 16b for movement in the horizontal direction, and the moving portion 13 that is movable in the plane in the vertical direction by the rails.

Two sets of the scanning unit and the inspection microscope lens 12 are provided so as face each other in order to simultaneously scan the front surface W1 and the rear surface W2 of the silicon wafer W. The holding member 20 can fix the silicon wafer W between the two inspection microscope lenses 12 facing each other at an inspection position.

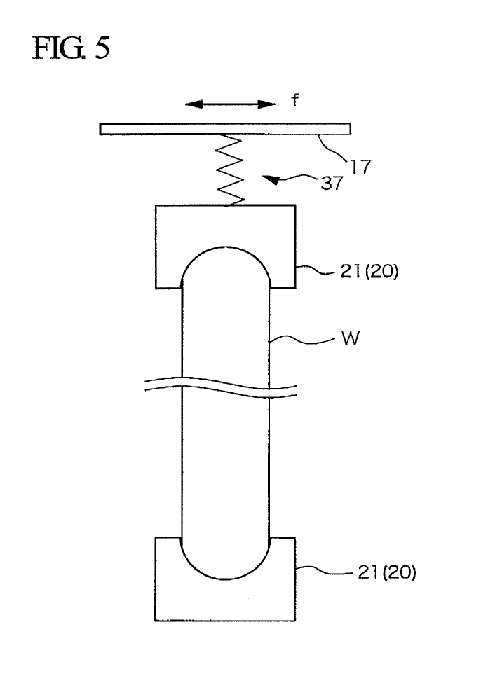

FIGS. 5, 6, and 7 are side views illustrating contact portions.

When the contact portion 21 of the holding member 20 is mounted to a supporting portion 17 that supports the contact portion 21, as shown in FIG. 5, at least one spring 37 is provided therebetween as a vibration preventing unit that can support the silicon wafer W so as to be sidable in the direction f of the central axis of the silicon wafer. The spring 37 presses the contact portion 21 from the outside of the outer circumferential portion of the silicon wafer W in the in-plane direction of the silicon wafer against the silicon wafer W. The spring constant of the spring 37 is set in the range capable of reducing vibration, on the basis of, for example, the diameter and the thickness of the silicon wafer W.

In this way, it is possible to reduce the vibration of the silicon wafer W in the vertical direction of the main surface of the silicon wafer, which is represented by “f” in FIG. 1, and prevent the contact between the inspection microscope lens 12 and the silicon wafer W.

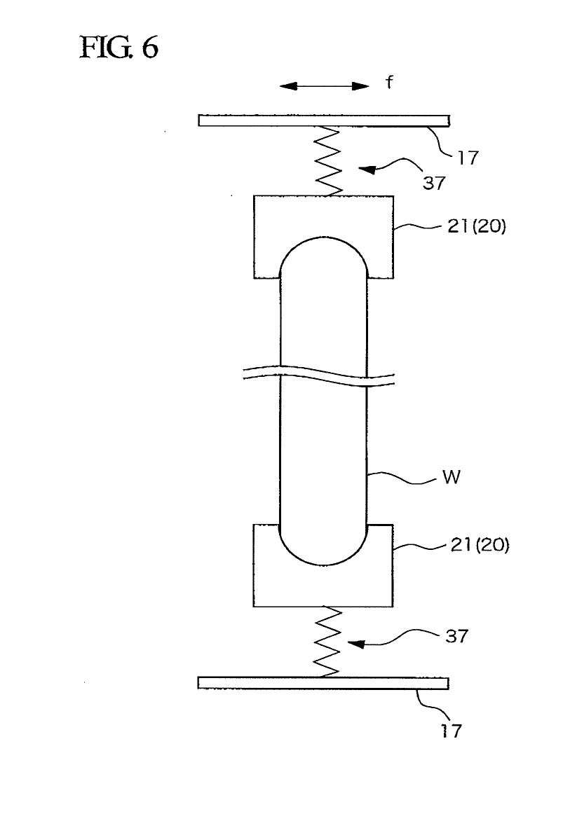

As shown in FIG. 6, the springs 37, which are vibration preventing units, may be provided to two or more contact portions 21. In this case, it is possible to further reduce the vibration of a wafer.

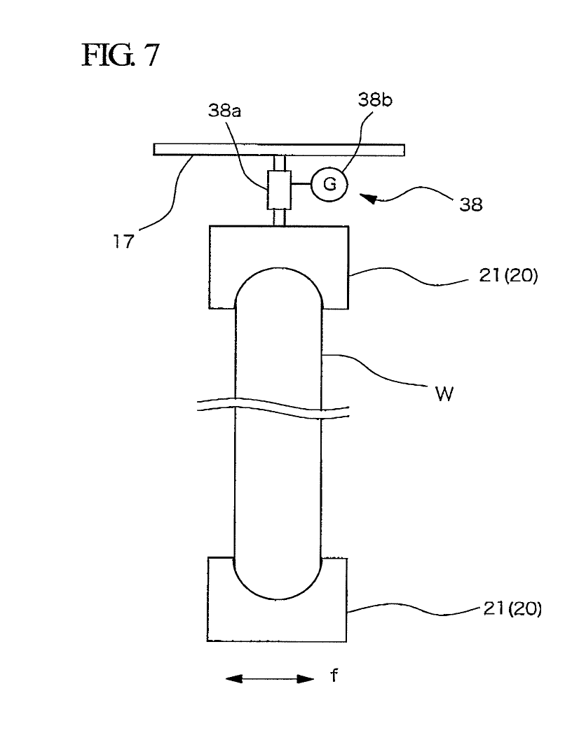

As shown in FIG. 7, as the vibration preventing unit, a variable vibration preventing unit 38 that connects the contact portion 21 and the supporting portion 17 and includes an air cylinder 38a and a gas adjusting mechanism 38b pressing the contact portion 21 against the silicon wafer W may be provided, and the gas adjusting mechanism 38b may be used to control the internal air pressure of the cylinder 38a to reduce vibration in correspondence with, for example, the diameter and the thickness of the silicon wafer W.

A robotic hand 11 may be provided as a mechanism that holds a wafer and sets the position of the wafer.

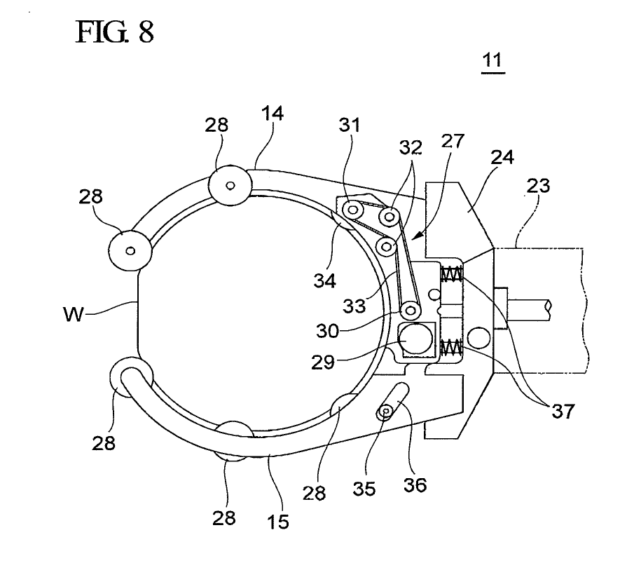

FIG. 8 is a cross-sectional view illustrating a guide roller and a wafer.

In FIG. 8, the robotic hand 11 includes a fixed holding arm 14 and a movable holding arm 15 that holds the circumferential portion of the silicon wafer W at both sides together with the fixed holding arm 14. The guide roller 28 has a surface that has the same curvature as the chamfered portion W3 of the silicon wafer W, and the surface serves as the contact portion 21 that contacts a wafer.

As shown in FIG. 8, the robotic hand 11, which is an example of the holding member (holding unit) 20, is provided at the leading end of a robot arm 23 that is three-dimensionally movable in the X, Y, Z, and θ directions. The robotic hand 11 includes a base portion 24, the fixed holding arm 14 that is fixed to the base portion 24 to clamp a wafer, the movable holding arm 15 that is slidably mounted to the base portion 24 and is driven by a clamp opening/closing motor (not shown), and a rotating unit 27 that rotates the silicon wafer W.

Each of the fixed and movable holding arms 14 and 15 is provided with a plurality of guide rollers 28 each having a groove for holding the outer circumferential portion of the silicon wafer W in an outer circumferential surface thereof.

The rotating unit 27 is provided so as to be placed from the base portion 24 to the base of the fixed holding arm 14, and includes a small driving motor 29, a driving pulley 30, a driven pulley 31, a guide roller 32, a power transmission belt 33, and a wafer rotating roller 34. The driving pulley 30 is rotated by the driving motor 29, and the tuning force is transmitted to the wafer rotating roller 34 through the belt 33 and the driven pulley 31. In this way, when the wafer rotating roller 34 is rotated the silicon wafer W held by the fixed and movable holding arms 14 and 15 can be rotated in the circumferential direction thereof.

In FIG. 8, reference numeral 35 denotes a guide pin that protrudes from the side surface of the base portion 24 and guides the sliding of the movable holding arm 15, reference numeral 36 denotes a long hole which is formed in the base of the movable holding arm 15 and into which the guide pin 35 is inserted, and reference numeral 37a denotes a cushion spring (vibration preventing unit).

As shown in FIG. 1, in the apparatus, the robotic hand 11 holds the silicon wafer W in the vertical direction. Therefore, it is possible to prevent the center of a silicon wafer W from drooping due to the weight of the silicon wafer, unlike the structure in which the silicon wafer W is held in the horizontal direction, or it is possible to prevent the silicon wafer W from being vibrated during inspection.

In this way, it is possible to set the surface detection device 12 so as to be accurately focused on the front surface W1 of the silicon wafer all the time during inspection. As a result, it is possible to accurately inspect the front surface W1 of the wafer.

Next, a method of inspecting a silicon wafer using the silicon wafer surface inspection apparatus will be described.

As shown in FIGS. 2A and 21B, the robotic hand 11 is operated to arrange the silicon wafer W held by the fixed and movable holding arms 14 and 15 in the vertical direction at the front position of the surface detection device 12.

Then, a process of inspecting the front surface W1 of the silicon wafer W starts. The surface detection device 12 captures light reflected from the front surface W1 of the silicon wafer W to detect the state of particles adhered to the front surface W1. In order to scan the front surface W1 of the silicon wafer W while changing the inspection position of the surface detection device 12 with respect to the front surface W1 of the silicon wafer W during inspection, the robotic hand 11 is operated or the driving motor 29 of the rotating unit 27 is driven to move the silicon wafer W in the X, Y, and Z directions or rotate it in the θ direction.

According to this embodiment, the distance T between the surface detection device 12 and the wafer surface W1 may be set to about 200 μm (180 to 300 μm) in order to prevent the vibration of the silicon wafer W. Therefore, it is possible to prevent the contact between a silicon wafer and an object lens during microscope inspection. It is possible to prevent the contamination, scratches, or damage of the front and rear surfaces of a wafer during inspection, and also prevent the vibration of a wafer during inspection. In addition, it is possible to maintain the distance between an object lens and a wafer surface during inspection to be constant, and accurately focus the surface detection device on the wafer surface during inspection. As a result, it is possible to improve the accuracy of inspection.

When the diameter φ of the silicon wafer W is 300 mm, vibration generally occurs with an amplitude in the range of 200 to 300 μm. When the diameter φ of the silicon wafer W is 200 mm, vibration generally occurs with an amplitude in the range of 100 to 200 μm. According to this embodiment, it is possible to reliably reduce the influence of the vibration.

In Japanese Patent No. 3744176, in a method of holding an outer circumferential portion of a semiconductor wafer, keeping the semiconductor wafer held in the vertical direction surface and radiating a laser beam to the surface of the semiconductor wafer in the vertical direction, a laser optical system can emit necessary light to the surface of the semiconductor wafer, without aging a part for radiating a laser beam to the wafer surface close to the wafer. In contrast, in this embodiment, the inspection apparatus performs microscope inspection on the main surface (including a rear surface) of a wafer to be inspected.

In this embodiment, it is necessary to arrange the object lens of the microscope close to the wafer in terms of characteristics of the object lens. In a microscope review station according to this embodiment, it is necessary to change the inspection positions of a wafer at a high speed, with he object lens being closed to the wafer, in order to increase an inspection speed. In this case, it is important that a wafer stage which is moved to each inspection position while being mounted with a wafer be maintained in parallel to the object lens.

However, as in Japanese Patent No. 3744176, in the case of the edge handling stage capable of holding a wafer in the horizontal direction, the center of the wafer droops due to its own weight, which makes it difficult to obtain sufficient parallelism. Therefore, all of the microscope stages for wafers having a diameter φ of 300 mm on the market are a rear surface contact type. However, in the rear surface contact type stage, there is a concern in that, when a wafer is loaded on the stage before shipment, particles will be adhered to the rear surface, or the rear surface of the wafer will be scratched. In contrast, the above-mentioned structure according to this embodiment makes it possible to prevent the deformation of a wafer due to its own weight and load a wafer in parallel to the object lens.

In addition, according to this embodiment, since the edge handling stage is arranged in the vertical direction, it is easy to maintain the parallelism between a wafer and an object lens, and it is possible to move the wafer relative to a microscope (inspection apparatus) at a high speed. As a result, it is possible to shorten the inspection time and reduce the manufacturing costs of a wafer.

A distance measuring unit, such as an ultrasonic sensor, may be provided in the vicinity of the inspection microscope lens 12 of the moving portion 13 in order to maintain the distance T1 between the wafer and the lens to be constant.

While preferred embodiments of the invention have been described and illustrated, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. An apparatus for inspecting the surface of a semiconductor wafer having a mirror surface and a chamfered outer circumferential portion by holding the outer circumferential portion of the semiconductor wafer, keeping the semiconductor held in the vertical direction and moving an inspection microscope lens toward the surface of the semiconductor wafer, the apparatus comprising:
a wafer holding member holding the semiconductor wafer and including two or more contact portions that contact the outer circumferential portion of the semiconductor wafer,
wherein the contact portions include:
a front surface contact portion that contacts a front-surface-side position of a chamfered portion of the semiconductor wafer; and
a rear surface contact portion that contacts a rear-surface-side position of the chamfered portion of the semiconductor wafer at the same position as that where the front surface contact portion is arranged in the circumferential direction of the semiconductor wafer.

2. The semiconductor wafer surface inspection apparatus according to claim 1,
wherein the curvature of a contact surface of the contact portion in the direction of the central axis of the semiconductor wafer is set to be equal to the curvature of the chamfered portion of the semiconductor wafer in order to prevent the vibration of the semiconductor wafer.

3. The semiconductor wafer surface inspection apparatus according to claim 1,
wherein the wafer holding member includes a vibration preventing unit supporting the contact portion that is positioned above the center of the semiconductor wafer held in the vertical direction such that the contact portion can slide in the direction of the central axis of the semiconductor wafer.

4. The semiconductor wafer surface inspection apparatus according to claim 3,
wherein at least one contact portion is provided below the center of the semiconductor wafer held in the vertical direction, and one contact portion is provided above the center of the semiconductor wafer held in the vertical direction.

5. The semiconductor wafer surface inspection apparatus according to claim 2,
wherein the wafer holding member includes a vibration preventing unit supporting the contact portion that is positioned above the center of the semiconductor wafer held in the vertical direction such that the contact portion can slide in the direction of the central axis of the semiconductor wafer.

6. The semiconductor wafer surface inspection apparatus according to claim 5,
wherein at least one contact portion is provided below the center of the semiconductor wafer held in the vertical direction, and one contact portion is provided above the center of the semiconductor wafer held in the vertical direction.
